(19) United States
(12) Patent Application Publication
(10) Pub. No.: US 2019/0202336 A1
(43) Pub. Date: Jul. 4, 2019

(54) VOICE CONTROL OF A VEHICLE LIGHT

(71) Applicant: FORD GLOBAL TECHNOLOGIES, LLC, Dearborn, MI (US)

(72) Inventors: Gaurav KUMAR, Cologne NRW (DE); Thorsten WARWEL, Duisburg NRW (DE)

(73) Assignee: FORD GLOBAL TECHNOLOGIES, LLC, Dearborn, MI (US)

(21) Appl. No.: 16/224,981

(22) Filed: Dec. 19, 2018

(30) Foreign Application Priority Data
Jan. 2, 2018 (DE) 10 2018 200 002.6

(51) Int. Cl. B60Q 1/04; H05B 37/02

(52) U.S. Cl. CPC B60Q 1/04; B60Q 2400/50; H05B 37/0272; H05B 37/0236

(57) ABSTRACT

A method is provided for controlling lighting equipment of a vehicle by means of a voice control apparatus, wherein the voice control apparatus is connected to a microphone and is designed to convert spoken instructions into control signals for the lighting equipment. In response to the control signals, the lighting equipment projects light in a manner creating an image on a non-horizontal surface in a vicinity of the vehicle. The non-horizontal surface may be an exterior wall of a building.

### CROSS-REFERENCE TO RELATED APPLICATIONS

This application claims foreign priority benefits under 35 U.S.C. § 119(a)-(d) to DE Application 10 2018 200 002.6 filed Jan. 2, 2018, which is hereby incorporated by reference in its entirety.

### TECHNICAL FIELD

The invention relates to a method for controlling lighting equipment of a vehicle by means of a voice control system.

### BACKGROUND

Modern lighting equipment of a vehicle more and more frequently has high-resolution headlamp systems or high-resolution exterior lighting. Lighting effects with a large range, high resolutions, and powerful contrasts are possible by means of this technology. A more or less narrow beam of light can be generated here, allowing details on the road or traffic signs to be marked in particular through lightening or darkening regions in the visual field. The high-resolution exterior lighting, as well as the very high contrast or contrast gradient that can be achieved in small regions, is used for the marking.

The manual operation of mechanical switches, including those of lighting equipment, is felt by the drivers of vehicles, in particular of motor vehicles, to be a tiresome activity which, moreover, impairs the driver's concentration on the road traffic. This applies particularly to situations of dim daylight or at night, when typically it is also dark inside the vehicle, and the operation of corresponding mechanical switches is difficult to handle. The object therefore arises of improving the operation of lighting equipment of a vehicle as compared with conventional techniques.

### SUMMARY

A first aspect of the invention relates to a method for controlling lighting equipment of a vehicle by means of a voice control apparatus, wherein the voice control apparatus is connected to a microphone and is designed to convert spoken instructions into control signals for the lighting equipment. The lighting equipment emits one or more beams of light in a manner to project alphanumeric symbols on a non-horizontal surface in a vicinity of the vehicle

The method is advantageous, since it operates independently of manual or sensor-based operating equipment. The lighting equipment can thus be operated only on the basis of voice commands, or in combination with manual or sensor-based operating equipment. The lighting equipment can thus advantageously be operated entirely in accordance with the will of the driver, independently of the time of day and of light sources, or in situations in which he does not reach the manual operating equipment, for example in the case of an accident. A further advantage of the method according to the invention is that the lighting equipment can also be operated on the basis of voice commands from other occupants who normally cannot reach the mechanical switches for manual operation.

An operation of the vehicle refers to a state in which a system of the vehicle is activated. That can refer to the drive source of the vehicle, but can also be an electrical system of the vehicle without the drive source being activated. The activation is performed here by the driver or by an occupant of the vehicle.

A vehicle can be a land vehicle, a water vehicle, or an aircraft. The vehicle is preferably a land vehicle, and in particular a motor vehicle.

A specific voice command refers to the use of a specific word or a specific word combination that is aimed at the execution of a specific action of the lighting equipment.

Lighting equipment refers to any light source comprised by the vehicle, i.e. connected to the vehicle or integrated into the vehicle, which is designed for the illumination of objects. This includes both the illumination in the interior of the vehicle as well as outside the vehicle, in particular however, outside the vehicle, and most particularly by front headlamps, rear lights and lights arranged at the side.

Preferably the lighting equipment comprises at least one high-resolution light source. In other words, the lighting equipment comprises at least one high-resolution light source, but can, however, also itself be the high-resolution light source.

Various types of high-resolution light source can be used.

The specific action of the lighting equipment may correspond to a change between high and low beams.

It a further aspect, the specific action may be executed by the lighting equipment for communication with other road users. This is advantageous, since complicated traffic situations can be handled more efficiently in comparison with communication through hand movements and hailing.

In a further aspect, the specific action of the lighting equipment may correspond to the generation of a specific pattern. The generation of specific patterns is advantageous, since in this way information for other road users can conveniently be projected onto a navigable ground, the natural surroundings, or onto an artificial structure in the surroundings. The advantage is in particular that the communication with other road users can be configured more effectively by means of the lighting equipment.

Preferably the pattern generated by the specific action of the lighting equipment comprises letters. In this way, information can be projected as text messages for other road users for example, on, the road. In particular, a specific text can be spoken through the microphone and projected through the voice control system.

The pattern generated by the specific action of the lighting equipment may comprise numbers. Speed and/or distance and/or time information for example can advantageously be projected in this way.

Preferably the pattern generated by the specific action of the lighting equipment comprises traffic symbols. These can even comprise symbols that are typically to be found on traffic signs, thus also road symbols such as a cross-walk.

A second aspect of the invention relates to a vehicle with at least one item of lighting equipment, in particular with high-resolution lighting equipment, and a voice control apparatus, wherein the voice control apparatus is connected to a microphone and is designed to convert spoken instructions into control signals for the lighting equipment.

The invention is explained in more detail with reference to the figures. Here:

### BRIEF DESCRIPTION OF THE DRAWINGS

FIG. 1 shows an illustration of a form of embodiment of the method according to the invention in a road situation;

FIG. 2 shows a block diagram of a form of embodiment of an arrangement for carrying out the method according to the invention;

FIG. 3 shows an illustration of exemplary symbols projected in the method; and

FIG. 4 shows a flow diagram of a form of embodiment of the method according to the invention.

### DETAILED DESCRIPTION

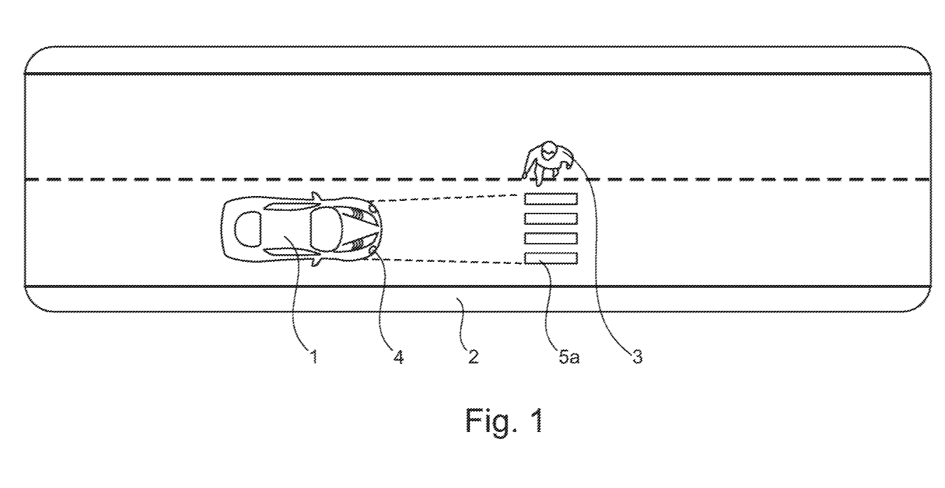

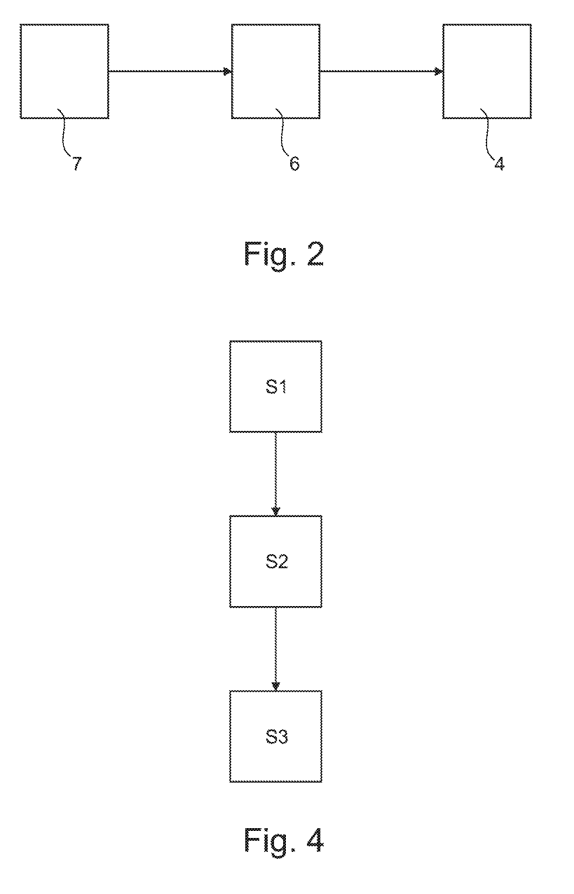

The method according to the invention is carried out with a vehicle 1 (FIG. 1). The vehicle is a limousine in FIG. 1, which is moving on a road 2. A further road user in the form of a pedestrian 3, who wants to cross the road in front of the vehicle, is present on the road 2. Alternatively or in addition to the pedestrian, other motor vehicles, cyclists, horse-drawn vehicles, additional pedestrians and so forth may also be located on the road 2.

The vehicle 1 comprises lighting equipment 4 which comprises a high-resolution light source in the front headlamp. High-resolution light sources can, alternatively or in addition, also be arranged in the rear lights and at the lighting equipment arranged at the sides of the vehicle. The term “high-resolution light source” will be used below, where the high-resolution light sources are arranged in the exterior lighting equipment of the vehicle 1. The vehicle 1 can, in addition, comprise conventional lighting equipment, e.g. conventional headlamps, LED lamps, interior lighting, flasher units and more, without being limited to them.

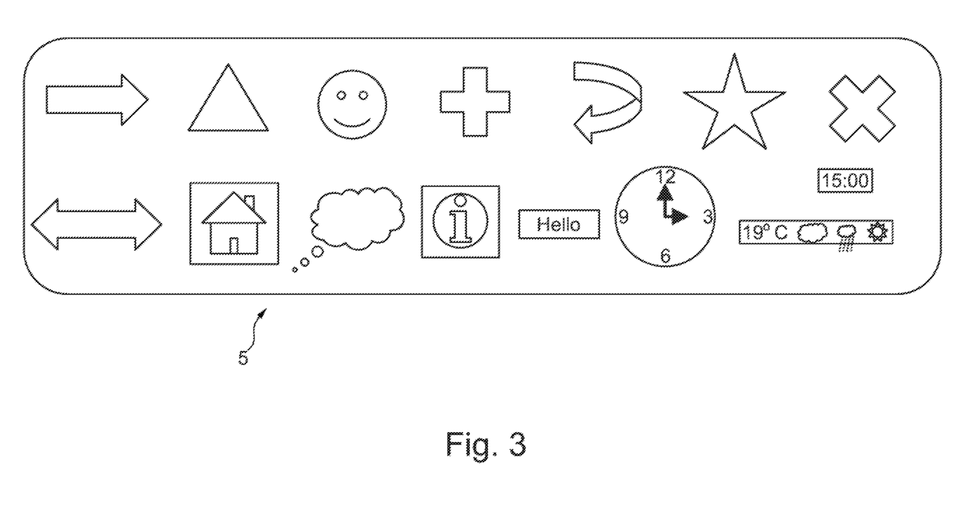

The high-resolution light source is designed such that in addition to a conventional illumination of the road 2 on which the vehicle 1 is moving, various patterns 5 can be generated by the high-resolution light source. A cross-walk 5a is projected onto the road 2 by way of example in FIG. 1. Further exemplary patterns 5 that can be generated by the high-resolution light source are illustrated in FIG. 3. The patterns in FIG. 3 comprise direction arrows, various signs for communication, as well as digital and analog indications of time, weather-related information and text messages.

The vehicle 1 comprises a voice control apparatus 6 that is connected to a microphone 7 and to the high-resolution light source, and is designed to convert spoken instructions into control signals for the lighting equipment 4. The connections between the microphone 7, voice control apparatus 6 and high-resolution light source can be implemented here through cables and/or can also function wirelessly. The microphone 7 is in the first place arranged in the region of the driver's seat, so that the driver can issue voice commands. It is, however, also possible for other persons in the vehicle 1 to issue voice commands. Additional microphones can also be arranged in the vehicle 1 for this purpose. An external microphone can, furthermore, be present, through which a person can issue voice commands from outside the vehicle, and which is connected to the voice control apparatus 6 by a wireless connection. An external microphone can, for example, be integrated into a remote control unit of a vehicle lock. The microphone of a mobile telephone can, furthermore, also be used to issue voice commands if an appropriate connection is established between the mobile telephone and the vehicle 1, or the voice control apparatus 6 of the vehicle 1.

In addition to the voice control apparatus 6, the high-resolution light source can also be operated manually, for example through a keypad or a lever. A sensor-based control is also additionally possible, for example for switching between high and low beams.

In a method according to the illustration of FIG. 4, the vehicle 1 is operated in a first step S1, i.e. placed in an activated state. The vehicle's on-board power network can, for example, be activated for this purpose, so that electricity from an on-board battery is available for the function of the high-resolution light source, or the drive source of the vehicle 1 can also be activated.

The vehicle 1 can be moving or stationary. In the situation illustrated in FIG. 1, the vehicle 1 has come to a halt. In order to communicate or indicate to the pedestrian 3 that he may cross the street, a spoken instruction is issued in a second step S2 through the microphone 7: “Cross-walk.” Alternatively a number, or a predetermined combination of letters and numbers, or a specific code word corresponding to a zebra crossing can also be used as the command.

In a third step S3, as is illustrated in FIG. 1, a control command, issued by the voice control apparatus 6 on the basis of the voice command, is issued to the high-resolution light source, and the cross-walk 5a is projected onto the road 2. The cross-walk 5a projected onto the road 2 illustrates the communication function of the method according to the invention. The fact that he can safely cross the road 2 is indicated in this way to the pedestrian by the driver of the vehicle 1.

The same or a different notification can be conveyed to the pedestrian through further symbols, e.g. those shown in FIG. 3. Writing, which is either predetermined or which corresponds to spoken words of the driver or another person, can, for example, also be projected onto the road 2. For this purpose, for example, a voice command that a text should be projected is given first, and then the corresponding text itself is spoken.

Communication with other road users is also possible, similarly to the interaction with the pedestrian. Thus, for example, traffic signs can also be projected onto the road 2, in order to clarify a specific situation to other road users, or to cause them to take a specific action. Conventional actions can, furthermore, be supported through the function of the high-resolution light source. For example, setting a flasher unit to indicate an intended turn or change of lane can be supported through arrows projected onto the road 2. A corresponding voice command is issued for this purpose which can, for example, take the form of “Arrow left” or “Arrow right.”

A projection of symbols or notifications onto objects lying outside the road 2, for example onto the exterior vertical surface of a structure (such as a wall of a building), is furthermore possible. The position of the desired projection can also be given for this purpose by means of voice commands, e.g. “45° right, distance 50 m, height 5 m”, wherein the data can be adjusted to set the sharpness of the projection.

What is claimed is:

1. A method comprising:
operating voice control apparatus of a vehicle to receive a spoken instruction and convert the spoken instruction into control signals for lighting equipment of the vehicle; and
operating the lighting equipment in response to the control signals to emit light in a manner to project alphanumeric symbols on a non-horizontal surface in a vicinity of the vehicle.

2. The method of claim 1, further comprising operating the lighting equipment in response to the control signals to project a traffic symbol.

3. The method of claim 1, wherein the lighting equipment comprises at least one high-resolution light source.

4. The method of claim 1, wherein the spoken instruction is received from a microphone located outside the vehicle and connected to the voice control apparatus by a wireless connection.

5. A method of operating lighting equipment of a motor vehicle comprising:
operating voice control apparatus of the vehicle to receive a spoken instruction and convert the spoken instruction into control signals for the lighting equipment; and
in response to the control signals, operating the lighting equipment to project light in a manner creating an image on a non-horizontal surface in a vicinity of the vehicle.

6. The method of claim 5, wherein the image comprises alphanumeric symbols.

7. The method of claim 5, wherein the image comprises a traffic symbol.

8. The method of claim 5, wherein the lighting equipment comprises at least one high-resolution light source.

9. The method of claim 5, wherein the spoken instruction is received from a microphone located outside the vehicle and connected to the voice control apparatus by a wireless connection.

10. A system for projecting an image onto a surface comprising:
a voice control apparatus mounted onboard a vehicle and operative to receive, via a microphone, a spoken instruction from an occupant of the vehicle and to convert the spoken instruction into electronic control signals; and
lighting equipment mounted onboard the vehicle and operative to receive the control signals and, in response thereto, project light in a manner creating an image on a non-horizontal surface in a vicinity of the vehicle, the image viewable by the vehicle occupant.

11. The system of claim 10, wherein the image comprises alphanumeric symbols.

12. The system of claim 10, wherein the image comprises a traffic symbol.

13. The system of claim 10, wherein the lighting equipment comprises at least one high-resolution light source.

14. The system of claim 10, wherein the voice control apparatus is further operative to receive a second spoken instruction from a second microphone located outside the vehicle and connected to the voice control apparatus by a wireless connection.
